(19) United States
(12) Patent Application Publication
(10) Pub. No.: US 2006/0227990 A1
(43) Pub. Date: Oct. 12, 2006

(54) Transducer Assembly and Method of Making Same

(75) Inventor: Dennis Ray Kirchhoefer, Plainfield, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 11/278,851

(22) Filed: Apr. 6, 2006

Related U.S. Application Data
(60) Provisional application No. 60/668,655, filed on Apr. 6, 2005.

(51) Int. Cl. H04R 25/00

(52) U.S. Cl. 381/328

(57) ABSTRACT

A transducer assembly includes at least one transducer. The transducer is disposed within a holder assembly. In this regard, the holder assembly is formed to have an interior and an exterior with the interior having a size to receive and retain the transducer. The exterior of the holder assembly is configured to be received and retained within a recess of a device.

### CROSS-REFERENCE TO RELATED APPLICATIONS

This patent claims benefit under 35 U.S.C. § 119(e) to U.S. Provisional Application Ser. No. 60/668,655 filed Apr. 6, 2005, the disclosure of which is hereby expressly incorporated herein by reference.

### TECHNICAL FIELD

This patent generally relates to transducers for use in listening devices, such as hearing aids or the like, and more particularly, to a transducer assembly with an engaging and locking feature formed therein and a sub-assembly component of a listening device using the transducer assembly.

### BACKGROUND

Hearing aid technology has progressed rapidly in recent years. Technology advancements in this field continue to improve the reception, wearing-comfort, life-span, and power efficiency of hearing aids. There are several different hearing aid styles known in the hearing aid industry: Behind-The-Ear (BTE), In-The-Ear or All-In-The-Ear (ITE), In-The-Canal (ITC), and Completely-In-The-Canal (CIC). Over the years, ITE hearing aids are desirable for many hearing aid users due to the size of these to retain partially or completely hidden in the ear canal.

Conventional ITE hearing aids with two omnidirectional microphones are generally known. The hearing aid for arrangement in the user's ear canal comprises a hollow plug adapted to the ear canal and a faceplate covering the opening of the plug. A microphone, a receiver, and a signal processor are disposed within the plug. The faceplate includes at least one opening which extends through the faceplate from the outside surface to the inside surface. At least one inlet tube or an input plate is attached to an acoustic port of the microphone in relationship with the opening to allow sound waves to enter. An assembly using an inlet tube often requires additional and costly, assembly steps to match an opening-inlet tube relationship. In addition, as the size of the hearing aid is reduced, limited space is available to accommodate the microphone. The cost of using two omnidirectional microphones having matched characteristics and the labor to assemble the hearing aid make such a hearing aid more costly to construct.

### BRIEF DESCRIPTION OF THE DRAWINGS

For a more complete understanding of the disclosure, reference should be made to the following detailed description and accompanying drawings wherein:

FIG. 1 is a partial perspective view of a first embodiment of the present invention showing a microphone assembly and a faceplate;

FIG. 2 is an exploded view of the first embodiment of the microphone assembly of the present invention;

FIG. 3. is a cross-sectional view of the first embodiment of the microphone assembly of the present invention;

FIG. 4 is a partial perspective view of the first embodiment of the present invention showing the microphone assembly secured to the faceplate;

FIG. 5 is an exploded view of a second embodiment of a microphone assembly of the present invention;

FIG. 6 is a cross-sectional view of the second embodiment of the microphone assembly of the present invention;

FIG. 7 is a partial perspective view of the second embodiment of the present invention showing the microphone assembly secured to the faceplate;

FIG. 8 is an exploded view of a third embodiment of a microphone of the present invention;

FIG. 9 is a cross-sectional view of the third embodiment of the microphone of the present invention;

FIG. 10 is a partial perspective view of the third embodiment of the present invention showing the microphone assembly secured to the faceplate;

FIG. 11 is a schematic view of a fourth embodiment of a microphone of the present invention; and

FIGS. 12a and 12b are further schematic views the fourth embodiment of the microphone.

The drawings are for illustrative purposes only and are not intended to be to scale.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

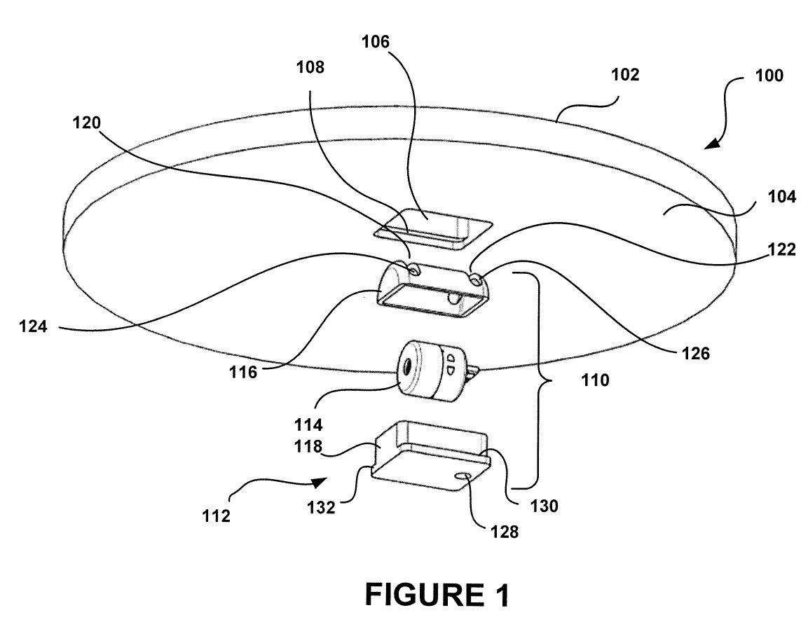

FIG. 1 illustrates a partial perspective view of a microphone assembly 110 secured to a faceplate 100 of an acoustic device, such as a hearing aid (not shown). The hearing aid may be a Behind-The-Ear (BTE), In-The-Ear (ITE), In-The-Canal (ITC), Completely-In-The-Canal (CIC), or the like. The acoustic device may be any type of listening device including a cellphone, PDA, portable computer, headset, and the like. In the embodiment shown of the acoustic device being a hearing aid, the hearing aid is an ITE. The faceplate 100 includes a first surface 102, a second surface 104, and a recess 106. A positioning member 108 is formed in the inner peripheral portion of the recess 106. The positioning member 108 is designed to receive the microphone assembly 110. As shown in FIG. 1, the recess 106 is formed in the faceplate 100 for positioning and insertion of the microphone assembly 110, which houses a microphone 114. An embodiment of the microphone assembly 10 will be described in greater detail below.

The microphone assembly 110 includes a holder 112 and the microphone 114. The microphone 114 may be, for example, a microphone with preamplifier disclosed in U.S. Provisional Patent Application Ser. No. 60/586,759, the disclosure of which is herein incorporated by reference in its entirety for all purposes. Other microphones may be used as well. The holder 112 may comprise a cover 116 and a base 118 fixedly attached to the cover 116, for example, by bonding with adhesive. However, it will be understood by those of ordinary skills in the art that any form of joining would suffice, including, for example, compression, or mechanical attachment at the edges, or the like. The holder 112 may be manufactured from a variety of materials such as, for example, non-conductive materials. It will be understood that the holder 112 may be shaped and manufactured in various ways and adapted to compliment the microphone 114. It will be further understood that the holder 112 or portions thereof may be formed integrally with the microphone housing. That is, a housing of the microphone 114 may be sized and configured to engage the recess in a manner similar to how the base 118 engages the recess for securing the microphone 114 within the recess, the microphone housing may incorporate the structure of the cover 114 include the acoustic ports and dust guards described below, and various combinations thereof. The concept of the holder may therefore extend to virtually any structure, whether provided as a separate structure or formed as a portion of the microphone housing that services the function of the holder 112.

A first acoustic port 120 and a second acoustic port 122, for example inlet ports for a microphone application, are formed on the upper surface of the cover 116. A dust guard 124, 126 may be attached to the cover 116. The dust guard 124, 126 may be shaped to correspond to the shape of the acoustic ports 120, 122, but may take the form of various shapes not necessarily corresponding to the acoustic ports 120, 122, and may have a number of different sizes. The dust guard 124, 126 may be made of cloth, felt, or wire mesh and may be attached to the inner surface of the cover 116 by adhesive or any other suitable method of attachment to cover the acoustic ports 120, 122. This helps to prevent debris from entering the microphone assembly 110 damaging the microphone 114 disposed within the holder 112. The dust guard 124, 126 may optionally improve the frequency response, create delay, and/or provide directional response.

An opening 128 is introduced on the bottom surface of the base 118 to provide electrical connection to be coupled to an electronics circuit (not shown) from the microphone 114. The opening 128 may be formed in any suitable manner such as drilling, punching, or molding. The base 118 is shown to have a first locking arm 130 and a second locking arm 132 for engagement with the engaging means formed in the faceplate 100 and such embodiment will be discussed in greater detail.

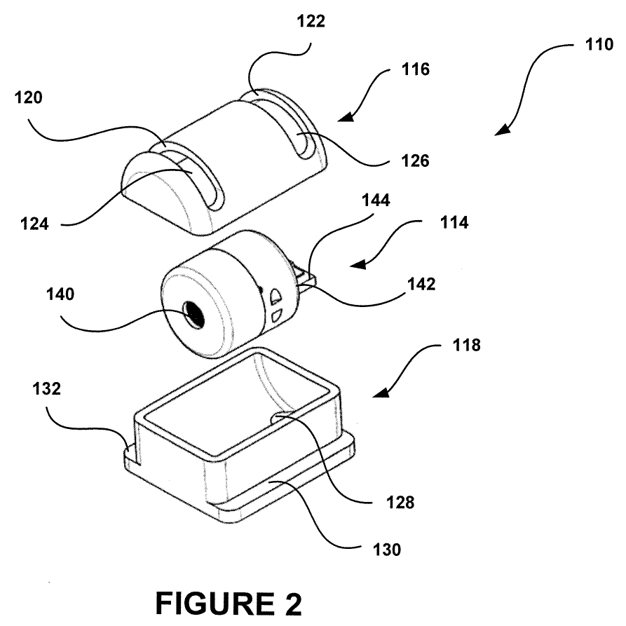

FIG. 2 illustrates an exploded view of the exemplary microphone assembly 110. The microphone 114 includes a first acoustic port 140, a second acoustic port 142, and a preamplifier 144 such as, for example, a source-follower field effect transistor (FET) extended through the second acoustic port 142. The first acoustic port 140 of the microphone 114 allows acoustic waves or sonic energy to enter the microphone 114 via the first acoustic port 120 of the holder 112. The second acoustic port 142 of the microphone 114 may be shaped in various ways and adapted to compliment the preamplifier 144. The preamplifier 144 is extended partially from the second acoustic port 142 to provide an electrical connection between the electronic circuit (not shown) and the preamplifier 144 via the opening 128 of the base 118. The second acoustic port 142 may also allow acoustic waves or sonic energy to enter the microphone 114 via the second acoustic port 122 of the holder 112.

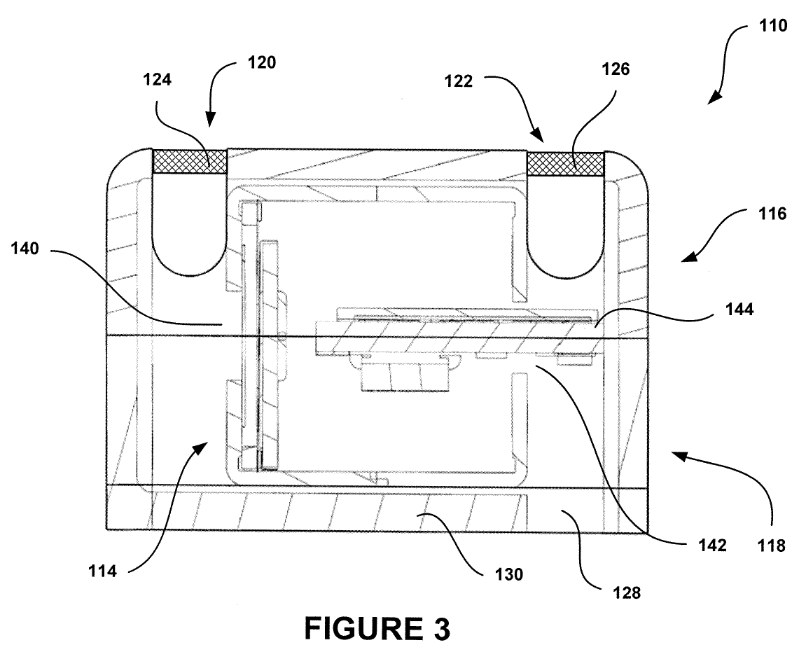

FIG. 3 illustrates a cross-sectional view of the exemplary microphone assembly 110. The microphone 114 is disposed within the holder 112 and a connecting wire (not shown) mounted to the top surface of the preamplifier 144 is extended through the opening 128 to provide an electrical connection to the electronic circuit (not shown) outside the microphone assembly 110. As shown in FIG. 3, the first acoustic port 120 is in acoustic communication with the first acoustic port 140 and the second acoustic port 122 is in acoustic communication with the second acoustic port 142 to allow acoustic waves or sonic energy to enter the microphone 114 within the holder 112 of the microphone assembly 110. This configuration may omit the need for the inlet tubes and may provide a less labor intensive manufacturing process.

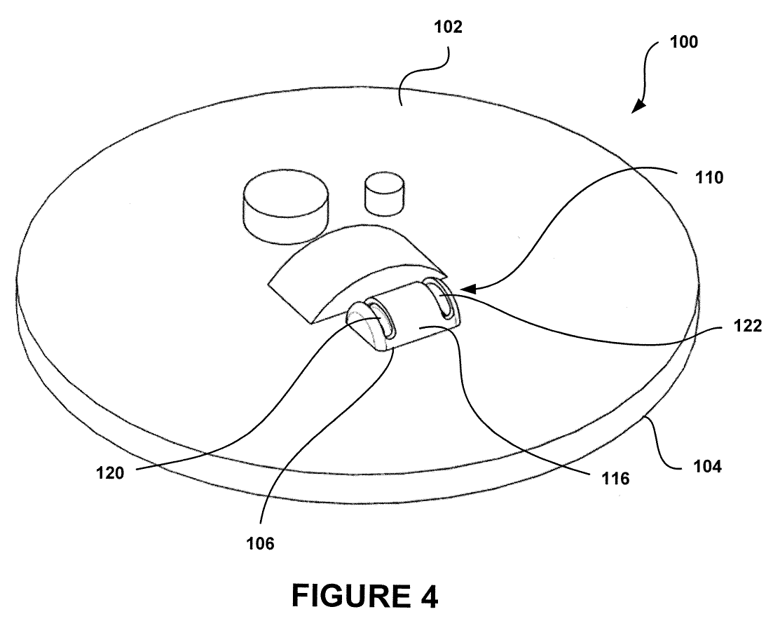

FIG. 4 illustrates a partial perspective view of a microphone assembly 110 secured to a faceplate 100 embodying the teachings of the present invention. When the microphone 114 is placed in a final or closed position, the base 118 (not shown) is fixedly attached to the cover 116, locking the microphone assembly 110 in position with the faceplate 100 by means of the first and second locking arms 130, 132 (not shown). The microphone assembly 110, as part of the faceplate 100 in this particular embodiment, may be at least partially fixed into the recess 106 in such a way that the first and second locking arms of the base 118 (not shown) are engaged to the positioning member 108 (not shown) formed in the inner peripheral portion of the recess 106. In this embodiment, the microphone assembly 110 may be less bulky and may require less labor to connect one microphone assembly 110 for use in a hearing aid. Further, with this embodiment in which the microphone assembly 110 is positioned within the recess 106 of the faceplate 100 may make it possible to achieve a smaller size of the hearing aid.

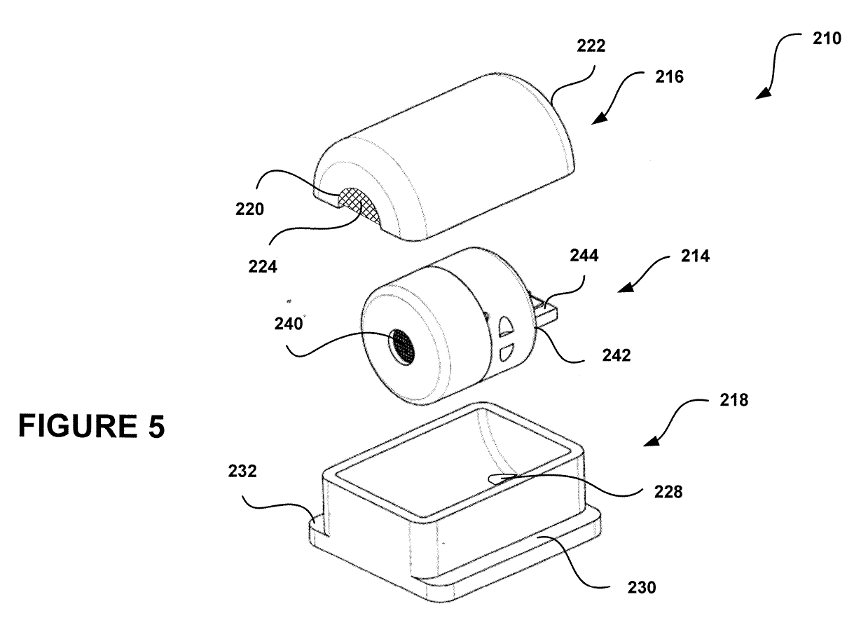

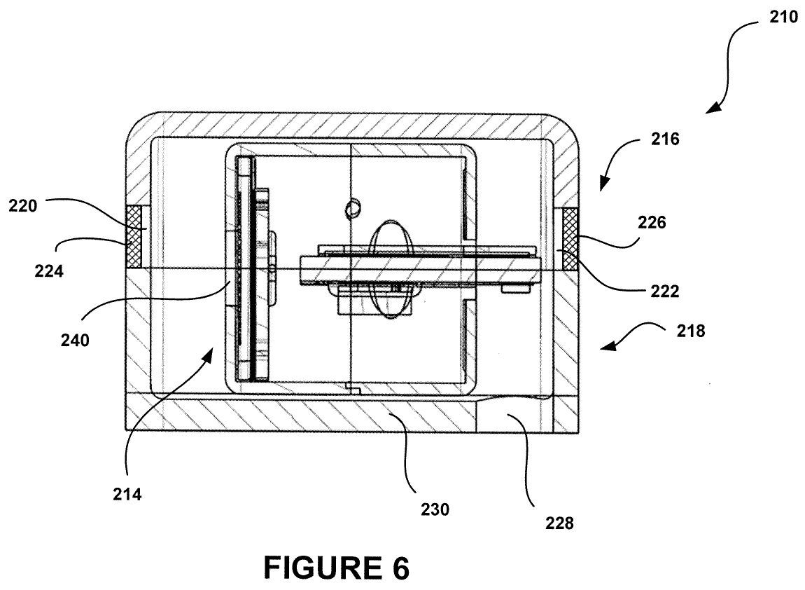

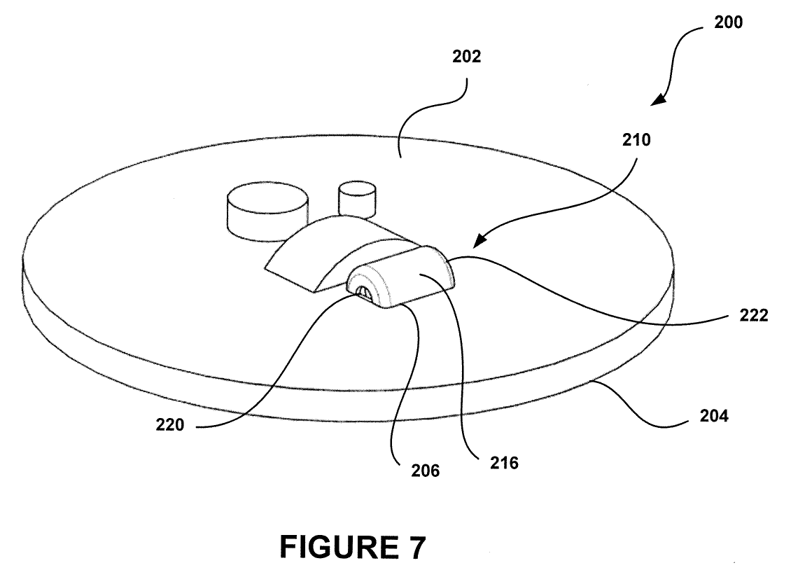

An alternate embodiment 210 of the present invention is illustrated in FIGS. 5 through 7. The embodiment 210 is similar to the embodiment illustrated in FIGS. 1 through 4, and like elements are referred to using like reference numerals wherein, for example, 110 and 114 correspond to 210 and 214, respectively. A difference between the embodiment 210 and the embodiment 110 is that a first acoustic port 220 and a second acoustic port 222 are formed on the side walls of a cover 216, as best illustrated in FIGS. 5 and 6. A dust guard 224, 226 may be attached to the inner surface of the cover 216 by adhesive or any other suitable method of attachment to cover the acoustic ports 220, 222. The first acoustic port 220 is in acoustic communication with a first acoustic port 240 and the second acoustic port 222 is in acoustic communication with a second acoustic port 242 to allow acoustic waves or sonic energy to enter the microphone 214 within the holder 212 of the microphone assembly 210. This configuration may omit the need for the inlet tubes and may provide a less labor intensive manufacturing process. Alternatively, one inlet port can be formed on the upper surface of the cover 216 and the other inlet port may be located on the side wall of the cover 216 to allow sound energy to enter and provide directional characteristics, i.e. bi-directional sensitivity in the microphone 214.

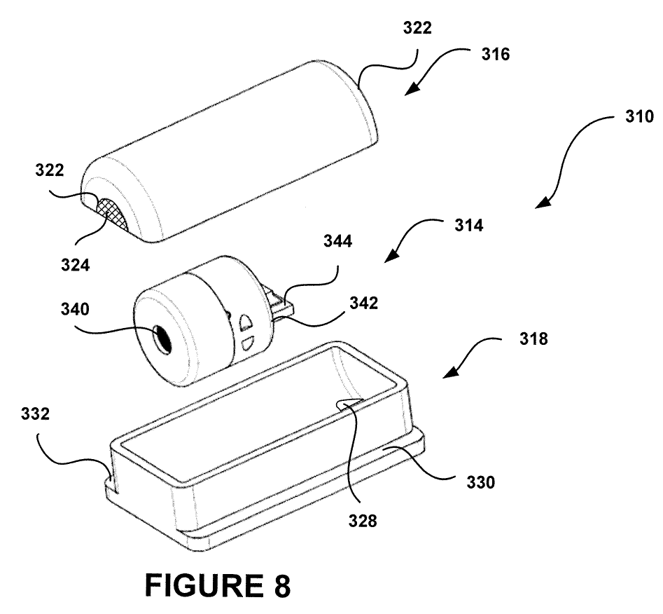

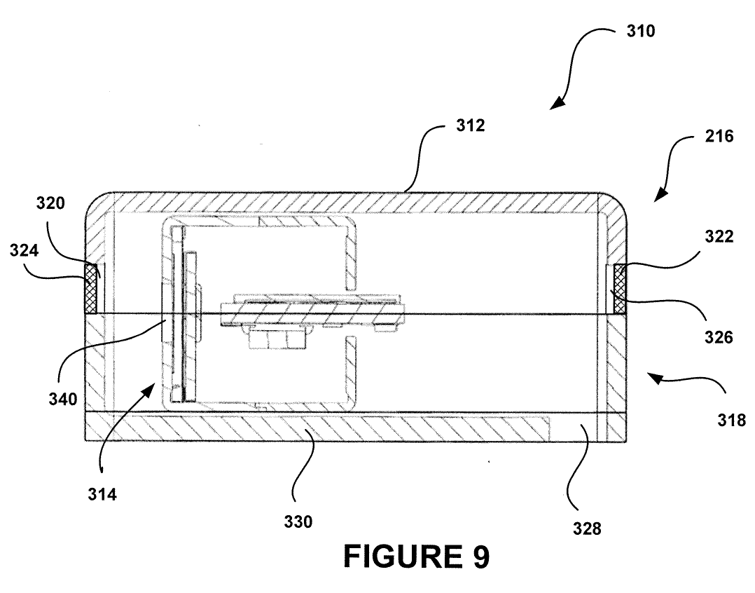

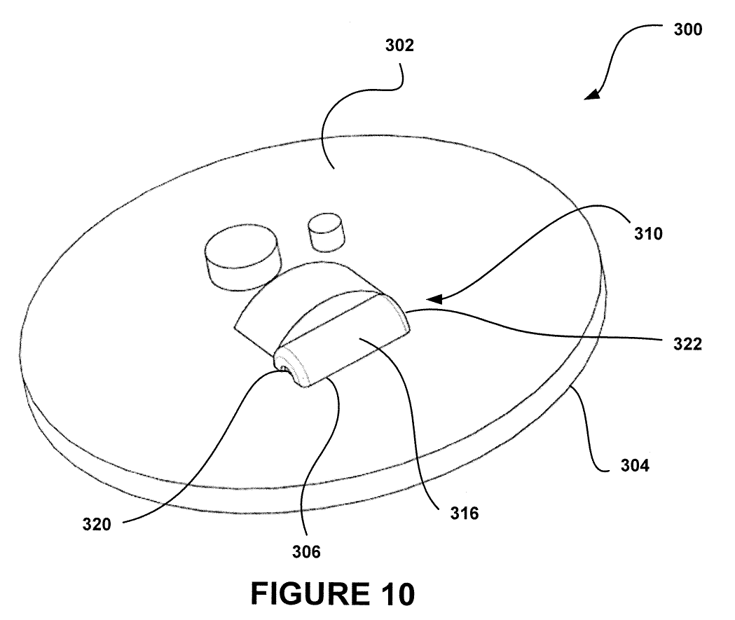

Another alternate embodiment 310 of the present invention is illustrated in FIGS. 8 through 10. The embodiment 310 is similar to the embodiment illustrated in FIGS. 5 through 7, and like elements are referred to using like reference numerals wherein, for example 210 and 214 correspond to 310 and 314, respectively. A difference between the embodiment 310 and the embodiment 210 is that the length of a holder 312 is increased such that the spacing between a first acoustic port 320 and a second acoustic port 322 is increased to help improve low frequency roll-off, for example. The increased port spacing between the first and second acoustic ports 320, 322 may help to improve the signal-to-noise ratio of a hearing aid. Alternatively, one acoustic port can be formed on the upper surface of the cover 316 and the other acoustic port may be located on the side wall of the cover 316 without affecting the port spacing between the two ports and also allows sound energy to enter and provide directional characteristics, i.e. bi-directional sensitivity in the microphone 214. This configuration may omit the need for the inlet tubes and may provide a less labor intensive manufacturing process.

In a variation to the above described embodiments, the inner surfaces 104, 204, 304 of the faceplates 100, 200, 300 may be formed with the bases 118, 218, 318. The bases 118, 218, 318 are designed to receive the microphone assemblies 110, 210, 310 to separate the front volume from the back volume. When the microphones 114, 214, 314 are placed in a final or closed position, the covers 116, 216, 316 are fixedly attached to the faceplates 100, 200, 300, locking the microphones 114, 214, 314 in position with the faceplates 100, 200, 300 by means of any suitable method of attachment.

Further understood from the various described embodiments is that the microphone assemblies 110, 210 or 310 may be directional microphone assemblies. Transducers to provide directional response to acoustic signals, including directional microphones, are well known and include devices that have a single housing and multiple inlet ports, multiple omni-directional microphones and associated circuitry providing a directional affect, combinations thereof and the like. Therefore, the microphone assemblies 110, 210 and 310 may consist of virtually any microphone type.

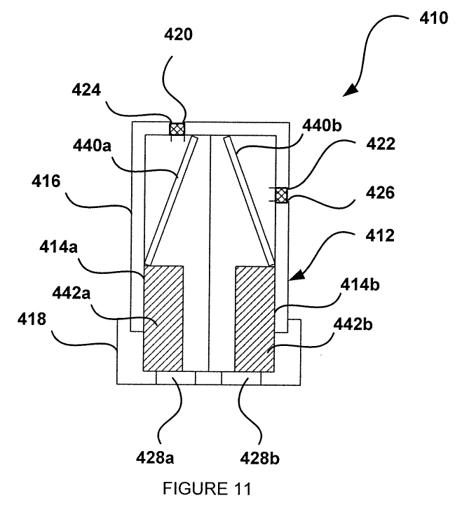

Referring now to FIG. 11, another alternative embodiment of a microphone assembly 410 includes first and second microphones 414a and 414b disposed within a holder 412. The embodiment 410 is similar to the foregoing described embodiments, and like elements are referred to using like reference numerals wherein, for example 410 and 414 correspond to 310 and 314, respectively, for example. The holder 412 including a cover 416 and a base 418 encloses the two microphones 414a and 414b, each of which may have the same configuration or which may be of different configurations. The holder 412 is designed to be coupled with a faceplate, as described herein in connection with the various embodiments of the invention. The microphones 414a and 414b are shown to have a thin design incorporating a diagonally disposed motor assembly (diaphragm, backplate and support) 440a and 440b, respectively. Each microphone also includes a circuit assembly 422a and 422b coupled to its respective diaphragm. Connecting wires may pass through a suitable opening 428a and 428b, respectively, formed within the holder 412. Although a single opening may be provided. Dust guards 424 and 426 may also be provided.

As shown in FIG. 11, the two microphones 414a and 414b are stacked and form a directional microphone, e.g., a conjoined pair directional microphone. A first acoustic port 420 corresponds to a front volume of the first microphone 414a is formed on a front surface of the cover 416 of the microphone 410. A second acoustic port 422 corresponds to a front volume of the second microphone 414b is formed on a side portion of the cover 416 of the microphone 410. However, the first and second acoustic ports 420 and 422 may be formed on any suitable surface of the holder 412 as the sound ports correctly align to the respective front volume of the corresponding microphones 414a and 414b.

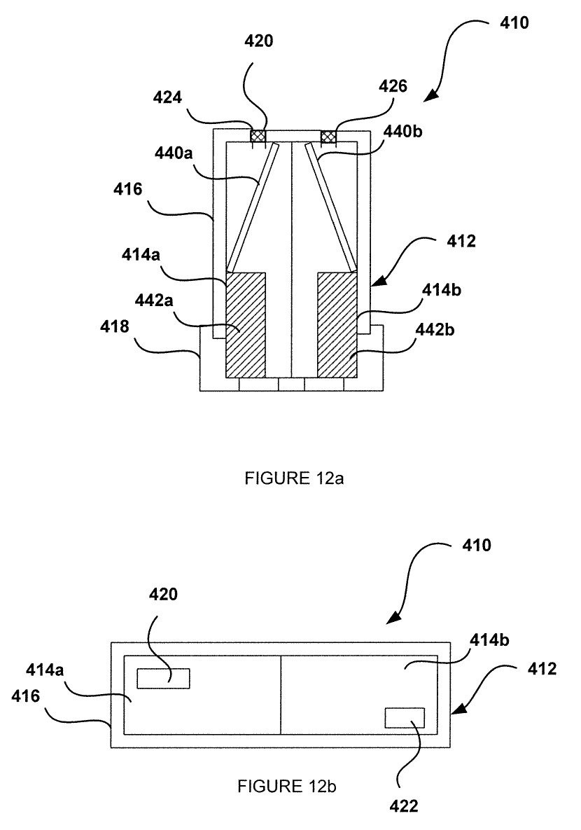

Now referring to FIGS. 12a-12b, the first and second acoustic ports 420 and 422 are each formed on a front surface of the cover 416 of the microphone 410. The acoustic ports 420 and 422 may take on virtually any layout, and may be disposed toward a center portion of the front of the cover 416, see FIG. 12a. Alternatively, the sound ports may be disposed toward the edges of the front of the cover, depending on the configuration of the cover as being circular, oval or rectangular, as shown. FIG. 12b illustrates the sound ports disposed at opposing corners, i.e., diagonally, on the cover 416. Still further, the acoustic ports may have an S, C, L or other configuration on the cover 416.

All references, including publications, patent applications, and patents, cited herein are hereby incorporated by reference to the same extend as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

We claim:

1. A transducer assembly comprising:
at least one transducer, the transducer having a housing;
a holder assembly for the transducer, the holder assembly formed to have an interior and an exterior, the interior having a size to receive and retain the transducer housing within the holder assembly; and
an exterior of the holder assembly configured to be received and retained within a recess of a device.

2. The transducer assembly of claim 1, wherein the at least one transducer comprises a first acoustic port, the holder assembly comprises a second acoustic port and wherein with the transducer assembly disposed within the interior, the first acoustic port and the second acoustic port are aligned.

3. The transducer of claim 3, a dust guard disposed within the second acoustic port.

4. The transducer of claim 1, the at least one transducer comprising first and second acoustic ports, the holder assembly comprises third and fourth acoustic ports and wherein with the transducer assembly disposed within the interior, the first acoustic port and the third acoustic port are aligned and the second acoustic port and the fourth acoustic port are aligned.

5. The transducer of claim 4, a dust guard disposed within each of the third and fourth acoustic ports.

6. The transducer of claim 1, the at least one transducer comprising either a microphone or a receiver.

7. The transducer of claim 1, the at least one transducer comprising a directional microphone.

8. The transducer of claim 7, the directional microphone comprising a first microphone and a second microphone, the first and second microphones being operable coupled as a directional microphone.

9. The transducer of claim 1, wherein the interior defines a volume adjacent to the transducer, the volume being coupled to an acoustic port of the transducer.

10. The transducer of claim 1, wherein the interior defines first and second volumes adjacent to the transducer, the first and second volumes being coupled to first and second acoustic ports of the transducer, respectively.

11. The transducer of claim 1, the holder assembly being designed to engage a positioning feature formed in the recess.

12. The transducer of claim 1, the holder assembly being non-conductive.

13. The transducer of claim 1, wherein the holder assembly comprises a base, the base being configured to be received within the recess.

14. The transducer of claim 13, the base being formed as part of the transducer housing.

15. The transducer of claim 1, wherein the holder assembly comprises a cover enclosing a portion of the transducer.

16. A sub-assembly component of a device, the sub-assembly component comprising:
a plate, the plate having a recess formed in the plate;
at least one transducer, the transducer having a housing;
a holder assembly for the transducer, the holder assembly formed to have an interior and an exterior, the interior having a size to receive and retain the transducer housing within the holder assembly; and
an exterior of the holder assembly configured to be received and retained within the recess.

17. The sub-assembly component of claim 16 comprising a face plate sub-assembly of a hearing aid.

18. The sub-assembly component of claim 17, the plate defining an outer surface of the hearing aid.

19. The sub-assembly component of claim 17, the at least one transducer comprising a microphone or a receiver.

20. The sub-assembly component of claim 16, wherein the at least one transducer comprises a first acoustic port, the holder assembly comprises a second acoustic port and wherein with the transducer assembly disposed within the interior, the first acoustic port and the second acoustic port are aligned.

21. The sub-assembly component of claim 16, the at least one transducer comprising first and second acoustic ports, the holder assembly comprises third and fourth acoustic ports and wherein with the transducer assembly disposed within the interior, the first acoustic port and the third acoustic port are aligned and the second acoustic port and the fourth acoustic port are aligned.

22. The sub-assembly component of claim 16, the at least one transducer comprising a directional microphone.

23. The sub-assembly component of claim 22, the directional microphone comprising a first microphone and a second microphone, the first and second microphones being operable coupled as a directional microphone.

24. The sub-assembly component of claim 16, wherein the interior defines a volume adjacent to the transducer, the volume being coupled to an acoustic port of the transducer.

25. The sub-assembly component of claim 16, wherein the interior defines first and second volumes adjacent to the transducer, the first and second volumes being coupled to first and second acoustic ports of the transducer, respectively.

26. The sub-assembly component of claim 16, the holder assembly being designed to engage a positioning feature formed in the recess.

27. The sub-assembly component of claim 16, the holder assembly being non-conductive.

28. The sub-assembly component of claim 16, wherein the holder assembly comprises a base, the base being configured to be received within the recess.

29. The sub-assembly component of claim 28, the base being formed as part of the transducer housing.

30. The sub-assembly component of claim 16, wherein the holder assembly comprises a cover enclosing a portion of the transducer.

31. A method of assembling an acoustic device, the method comprising:
providing at least one transducer;
operably associating the transducer with a holder assembly, the holder assembly having an exterior;
securing the holder assembly to the acoustic device by engaging the exterior with a recess formed in the acoustic device.

32. The method of claim 31, wherein the at least one transducer comprises a first acoustic port and the holder assembly comprises a second acoustic port and wherein disposing the transducer within the interior portion comprises aligning the first acoustic port and the second acoustic port.

33. The method of claim 32 comprising disposing a dust guard within the second acoustic port.

34. The method of claim 31, wherein the at least one transducer comprises first and second acoustic ports and the holder assembly comprises third and fourth acoustic ports and wherein disposing the transducer assembly within the interior comprises aligning the first acoustic port and the third acoustic port and the second acoustic port and the fourth acoustic port.

35. The method of claim 34, comprising disposing a dust guard disposed within each of the third and fourth acoustic ports.

36. The method of claim 31, wherein providing at least one transducer comprises providing either a microphone or a receiver.

37. The method of claim 31, wherein providing at least one transducer comprises providing a directional microphone.

38. The method of claim 37, wherein providing a directional microphone comprises providing a first microphone and a second microphone and operable coupling the first and second microphones as a directional microphone.

39. The method of claim 31 comprising providing the interior with a volume, disposing the volume adjacent to the transducer, and coupling the volume to an acoustic port of the transducer.

40. The method of claim 31 comprising providing the interior with first and second volumes, disposing the first and second volumes adjacent to the transducer, and coupling the first and second volumes to first and second acoustic ports, respectively, of the transducer.

41. The method of claim 31, wherein engaging the exterior with a recess formed in the acoustic device comprises engaging a positioning feature formed in the recess with the exterior.

42. The method of claim 31, wherein engaging the exterior with a recess formed in the acoustic device comprises engaging a portion of the transducer housing with the recess.
